(19) United States
(12) Patent Application Publication
(10) Pub. No.: US 2022/0109210 A1
(43) Pub. Date: Apr. 7, 2022

(54) ENERGY STORAGE UNIT HAVING A RACK ASSEMBLY AND A PLURALITY OF BATTERY MODULES

(71) Applicant: BLUE SOLUTIONS CANADA INC., Boucherville (CA)

(72) Inventors: Claude CARIGNAN, Varennes (CA); Jean CARON, St-Eugene-de-Grantham (CA); Christian DESMARAIS-TREPANIER, Mont-Saint-Hilaire (CA)

(21) Appl. No.: 17/487,420

(22) Filed: Sep. 28, 2021

Related U.S. Application Data
(60) Provisional application No. 63/086,708, filed on Oct. 2, 2020.

(51) Int. Cl. H01M 50/209; H01R 4/48; H01M 50/507; H01M 50/296; H01M 50/244; H01M 50/264; H01M 50/503

(52) U.S. Cl. CPC H01M 50/209; H01R 4/48; H01M 50/507; H01M 50/503; H01M 50/244; H01M 50/264; H01M 50/296

(57) ABSTRACT

An energy storage unit having a rack assembly and a plurality of battery modules is disclosed. The rack assembly has a frame having at least one shelf adapted to receive the battery modules thereon, a plurality of first electrical connectors, a system control unit, and a main power terminal. Each battery module has two second electrical connectors that are each selectively slidingly connected to one first electrical connector. The first and second electrical connectors are configured such that inserting, by sliding, the battery modules on the at least one shelf connects the first and second electrical connectors. An energy storage unit having battery modules each with an engaging bracket selectively fixedly connected thereto, and a frame having a plurality of stoppers having an elevated member configured to limit vertical movement of one of the battery modules, when in a predetermined position, by selectively engaging the engaging bracket is also disclosed.

### CROSS-REFERENCE TO RELATED APPLICATION

The present application claims priority to U.S. Provisional Patent Application Ser. No. 63/086,708, filed Oct. 2, 2020, entitled “Energy Storage Unit Having a Rack Assembly and a Plurality of Battery Modules”, which is incorporated by reference herein in its entirety.

### FIELD OF TECHNOLOGY

The present technology relates to an energy storage unit having a rack assembly and a plurality of battery modules.

### BACKGROUND

Energy storage units are becoming more and more commonly used to store energy harvested from various power generation sources, such as wind turbines or solar panels. The stored energy can then be redistributed from the energy storage units as necessary.

Energy storage units typically function with high-voltage battery modules. The total voltage of one of these energy storage units generally ranges from 400 to 1000 volts when fully connected. As such there is usually a number of high voltage points in these energy storage units.

However, electrically connecting the battery modules to one another and to a main power terminal usually requires personnel to handle the battery modules near the high voltage points, which can be time consuming and hazardous.

Thus, there is a desire for an energy storage unit that could mitigate the above-mentioned issues.

### SUMMARY

It is an object of the present technology to ameliorate at least some of the inconveniences present in the prior art.

The present technology relates to an energy storage unit that has a rack assembly and battery modules. The present technology facilitates the connection between the battery modules and a main power terminal of the rack assembly such that the battery modules can be connected to the power terminal without requiring an installer to go to the rear of the rack assembly, where there are high voltage sources, while also avoiding the need for the installer to manipulate the connectors of the battery modules and the rack assembly. The battery modules are inserted on a shelf of the rack assembly by sliding the battery modules until they are electrically connected to the connectors of the rack assembly.

According to one aspect of the present technology, there is provided an energy storage unit including a rack assembly and a plurality of batter modules supported by the rack assembly. The rack assembly includes a frame, a plurality of first electrical connectors, a system control unit and a main power terminal. The frame has at least one shelf. The at least one shelf is adapted to receive the plurality of battery modules thereon. The plurality of first electrical connectors are connected to the frame and are electrically insulated from the frame. The system control unit is connected to the frame, and the main power terminal is selectively electrically connected to the plurality of battery modules. Each battery module of the plurality of battery modules has two second electrical connectors at a rear thereof. Each one of the two second electrical connectors is selectively slidingly connected to one first electrical connector of the plurality of first electrical connectors. The first and second electrical connectors are configured such that inserting the plurality of battery modules on the at least one shelf by sliding the plurality of battery modules on the at least one shelf connects the second electrical connectors with the first electrical connectors.

In some embodiments, the first electrical connectors are power busbars, and the second electrical connectors are busbar blade connectors.

In some embodiments, the first electrical connectors are busbar blade connectors, and the second electrical connectors are power busbars.

In some embodiments, the plurality of second electrical connectors includes a base portion, a resilient upper arm and a resilient lower arm. The base portion is selectively connected to the battery module, the resilient upper arm is connected to the base portion; and the resilient lower arm is connected to the base portion. The resilient upper and lower arms define a connecting region therebetween and have an initial position. The resilient upper and lower arms are biased toward the initial position upon displacement of any one of the resilient upper and lower arms.

In some embodiments, the plurality of second electrical connectors each include a base portion, an upper arm and a lower arm. The base portion is selectively connected to the battery module and defines a center plane. The upper arm is connected to the base portion and has a first upper arm member, a second upper arm member and a third upper arm member. The first upper arm member extends away from the base portion to a first end of the first upper arm. The second upper arm member is connected to the first end of the first upper arm member, and extends diagonally from the first end of the first upper arm toward the center plane and the base portion to a second end of the second upper arm. The third upper arm member is connected to the second end of the second upper arm member, and extends toward the base. The lower arm is connected to the base portion and has a first lower arm member, a second lower arm member and a third lower arm member. The first lower arm member extends away from the base portion to a first end of the first upper arm. The second lower arm member is connected to the first end of the first lower arm member, and extends diagonally from the first end of the first lower arm toward the center plane and the base portion to a second end of the second lower arm. The third lower arm member is connected to the second end of the second lower arm, and extends toward the base. The third upper arm member and the third lower arm member define a connecting region therebetween, and the upper and lower arm having an initial position, and being biased toward the initial position.

In some embodiments, each first electrical connector of the plurality of first electrical connectors is vertically aligned with at least one second electrical connector of the plurality of second electrical connectors within a tolerance of five millimetres or less.

In some embodiments, the tolerance is three millimetres or less.

In some embodiments, the tolerance 1.5 millimetres or more.

In some embodiments, at least some battery modules of the plurality of battery modules are connected in series.

In some embodiments, at least some battery modules of the plurality of battery modules are connected in parallel.

In some embodiments, the plurality of battery modules includes a first group of battery modules connected in series, and a second group of battery modules connected in series, the first group of battery modules being connected in parallel with the second group of battery modules.

In some embodiments, the frame has a plurality of guiding brackets; and each battery module of the plurality of battery modules is received laterally in one guiding bracket of the plurality of guiding brackets.

In some embodiments, each of the plurality of guiding brackets forms a C-shaped channel.

In some embodiments, the frame further includes a plurality of stoppers, the plurality of stoppers stopping the plurality of battery modules from sliding past a predetermined position on the at least one shelf when the second electrical connectors are connected to the first electrical connectors.

In some embodiments, each battery module of the plurality of battery modules has a fixing bracket, the fixing bracket being selectively fixedly connected to the frame.

In some embodiments, the at least one shelf is at least six shelves, and each one of the at least six shelves receives at least one battery module of the plurality of battery modules.

According to another aspect of the present technology, there is provided an energy storage unit having a rack assembly, and a plurality of battery modules supported by the rack assembly. Each battery module of the plurality of battery modules defines a first module end and a second module end, the second module end having an engaging bracket selectively fixedly connected thereto. The rack assembly includes a frame, a system control unit, and a main power terminal. The frame has at least one shelf adapted to receive the plurality of battery modules therein, and a plurality of stoppers each defining a first end and a second end, the first end having an elevated member. The system control unit is connected to the frame; and the main power terminal is selectively electrically connected to the plurality of battery modules. Each battery module is selectively slidingly inserted in the rack assembly by sliding on the at least one shelf to a predetermined position, and when one of the plurality of battery modules is in the predetermined position, a corresponding one of the elevated member of the plurality of stoppers, limits vertical movement of the one of the plurality of battery modules by selectively engaging the engaging bracket of the one of the plurality of battery modules.

In some embodiments, the corresponding one of the elevated member of the plurality of stoppers limits vertical movement of the one of the plurality of battery modules to less than five millimetres.

In some embodiments, the vertical movement is limited to less than three millimetres.

In some embodiments, the energy storage unit further includes a plurality of first electrical connectors connected to the frame, the plurality of first electrical connectors being electrically insulated from the frame; and each battery module of the plurality of battery modules having two second electrical connectors at a rear thereof, each one of the two second electrical connectors being selectively slidingly connected to one first electrical connector of the plurality of first electrical connectors.

In some embodiments, the first electrical connectors are power busbars, and the second electrical connectors are busbar blade connectors.

In some embodiments, at least some battery modules of the plurality of battery modules are connected in series.

In some embodiments, at least some battery modules of the plurality of battery modules are connected in parallel.

In some embodiments, the plurality of battery modules includes a first group of battery modules connected in series; and a second group of battery modules connected in series, the first group of battery modules being connected in parallel with the second group of battery modules.

In some embodiments, the frame has a plurality of guiding brackets; and each battery module of the plurality of battery modules is received laterally in one guiding bracket of the plurality of guiding brackets.

In some embodiments, each of the plurality of guiding brackets forms a C-shaped channel.

In some embodiments, the frame further includes a plurality of stoppers, the plurality of stoppers stopping the plurality of battery modules from sliding past the predetermined position on the at least one shelf when the second electrical connectors are connected to the first electrical connectors.

In some embodiments, each battery module of the plurality of battery modules has a fixing bracket, the fixing bracket being selectively fixedly connected to the frame.

In some embodiments, the at least one shelf is at least six shelves, and each one of the at least six shelves receives at least one battery module of the plurality of battery modules.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying figures and the appended claims

### BRIEF DESCRIPTION OF THE FIGURES

For a better understanding of the present technology, as well as other aspects and further features thereof, reference is made to the following description which is to be used in conjunction with the accompanying figures, where:

FIG. 1 is a perspective view taken from a front, top, left side of an energy storage unit;

FIG. 2 is a partially exploded, perspective view taken from a front, top, left side of a rack assembly of the energy storage unit of FIG. 1;

FIG. 3 is a partially exploded, perspective view taken from a rear, top, right side of the rack assembly of FIG. 2;

FIG. 4 is a partially exploded, perspective view taken from the front, top, left side of the rack assembly of FIG. 2, with front, rear and lateral access panels and front, rear and right thermal insulation panels being omitted;

FIG. 5 is a partially exploded perspective view taken from a rear, bottom, left side of a frame of the rack assembly of FIG. 2;

FIG. 6 is a partially exploded perspective view taken from a rear, top, right side of the frame of FIG. 5 and a rear wall thereof;

FIG. 7 is a close-up perspective view of portion 7-7 of FIG. 6 showing a rear, top, right side of a guiding bracket and a stopper of the frame of FIG. 5;

FIG. 8 is a perspective view taken from a front, top, right side of a rear wall portion, edge power busbars and intermediate power busbars of the rear wall of FIG. 6;

FIG. 9 is a perspective view taken from a front, bottom, left side of one of the edge power busbars of FIG. 8;

FIG. 10 is a perspective view taken from a front, bottom, left side of one of the intermediate power busbars of the FIG. 8;

FIG. 11 is a schematic rear elevation view of the energy storage unit of FIG. 1 with the rear access panels, the rear thermal insulation panels and the rear wall of the rack assembly being omitted to show electric connections of the battery modules;

FIG. 12 is a perspective view taken from a front, top, left side of one of the battery modules of FIG. 11;

FIG. 13 is a perspective view taken from a rear, top, left side of the battery module of FIG. 11;

FIG. 14 is a partially exploded perspective view taken from a rear, top, right side of the battery module of FIG. 11;

FIG. 15 is a perspective view taken from a rear, bottom, left side of a busbar blade connector of the battery module of FIG. 11;

FIG. 16 is a rear elevation view of the busbar blade connector of FIG. 15;

FIG. 17 is a cross-sectional view of the busbar blade connector of FIG. 15 taken through line 17-17 of FIG. 16;

FIG. 18 is a perspective view taken from a front, top, left side of an alternate embodiment of an energy storage unit with some battery modules being inserted in a rack assembly thereof, and with a forward access panel and a forward thermal insulation panel being omitted;

FIG. 19 is a cross-sectional view of the energy storage unit of FIG. 18, taken through plane 19-19 of FIG. 18;

FIG. 20 is a cross-sectional view of the energy storage unit of FIG. 18, taken through plane 20-20 of FIG. 18;

FIG. 21 is a perspective view taken from a front, top, left side of the energy storage unit of FIG. 18, with all battery modules being inserted in the rack assembly;

FIG. 22 is a perspective view taken from a rear, top, left side of the energy storage unit of FIG. 21 with part of a rear wall being omitted; and

FIG. 23 is a cross-sectional view of a portion of an alternative embodiment of an energy storage unit, taken through a vertical plane extending through a rear of a battery module and a rear of a rack of the energy storage.

### DETAILED DESCRIPTION

The present detailed description is intended to be a description of illustrative examples of the present technology.

The present technology relates to an energy storage unit 100 having a rack assembly 200 and battery modules 400, where the battery modules 400 are supported by the rack assembly 200. The energy storage unit 100 is configured to facilitate electrical connection between the battery modules 400 to a main power terminal 160 and to limit movement of the battery modules 400 once they reach a predetermined position. In the predetermined position, the battery modules 400 are electrically connected to the main power terminal 160.

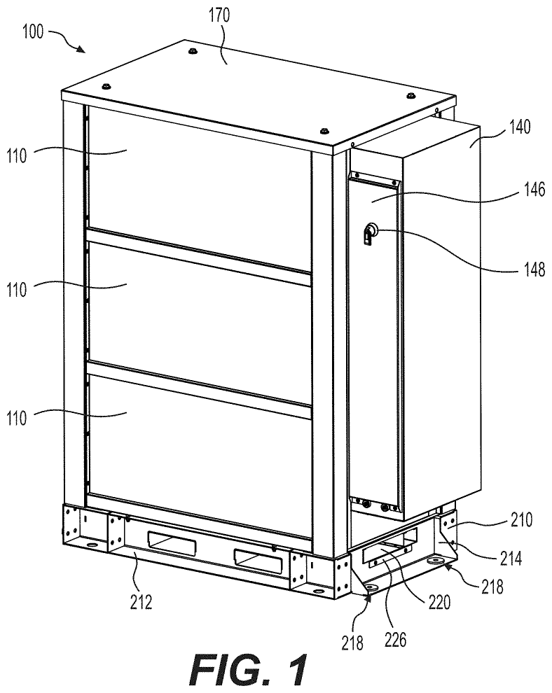

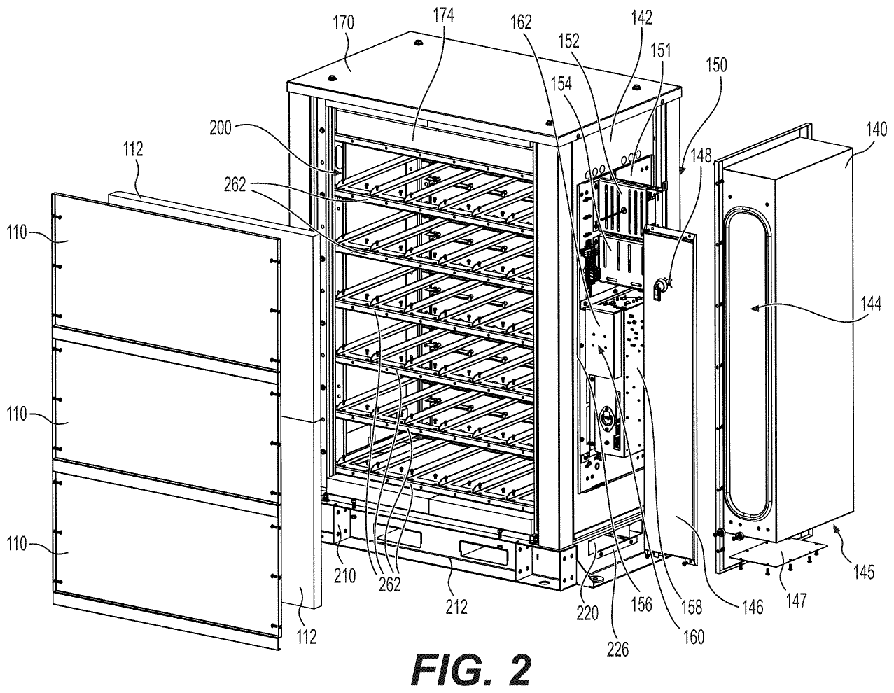

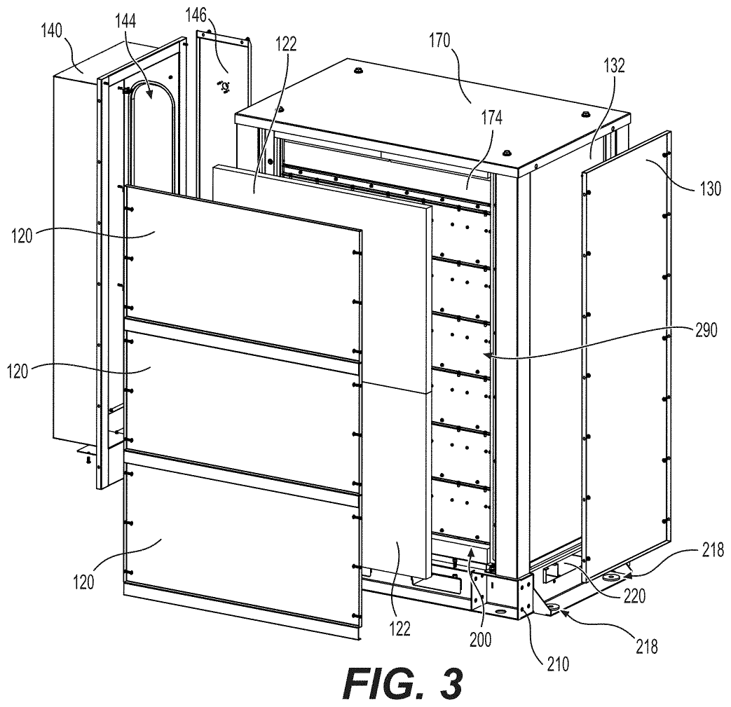

Referring to FIGS. 1 to 4, the energy storage unit 100 will be described in more detail. The rack assembly 200 has a frame 250 to which other components of the rack assembly 200 are mounted. The rack assembly 200 has three forward access panels 110 on a front thereof. Two forward thermal insulation panels 112 are provided between the forward access panels 110 and the frame 250. The forward access panels 110 and the forward thermal insulation panels 112 are connected to the frame 250. It is contemplated that in other embodiments, the number of forward access panels 110 and/or the number of forward thermal insulation panels 112 could be different. As will be explained in greater detail below, in the present embodiment, the forward access panels 110 and the forward thermal insulation panels 112 are removable so as to provide access to an interior of the rack assembly 200 from a front thereof

On its rear side, the rack assembly 200 has three rear access panels 120. Two rear thermal insulation panels 122 are provided between the rear access panels 120 and the frame 250. The rear access panels 120 and the rear thermal insulation panels 122 are connected to the frame 250. It is contemplated that in other embodiments, the number of rear access panels 120 and/or the number of rear thermal insulation panels 122 could be different. In some embodiments, the rear access panels 120 and the rear thermal insulation panels 122 could be removable so as to provide access to the interior of the rack assembly 200 from a rear thereof

On its right side, the rack assembly 200 has one lateral access panel 130. One lateral thermal insulation panel 132 is provided between the lateral access panel 130 and the frame 250. The lateral access panel 130 and the lateral thermal insulation panel 132 are connected to the frame 250. It is contemplated that in other embodiments, there could be more than one lateral access panel 130 and/or more than one lateral thermal insulation panel 132. It is also contemplated that in some embodiments, the lateral access panel 130 and the lateral thermal insulation panel 132 could be removable so as to provide access to the interior of the rack assembly 200 from the right side thereof

On its left side, the rack assembly 200 has an electro-technical outer shell 140. The electro-technical outer shell 140 is adapted to cover an electrical unit 150 of the energy storage unit 100. The electrical unit 150 is connected to a supporting plate 151 which is in turn connected to a lateral thermal insulation panel 142. The lateral thermal insulation panel 142 is connected to the frame 250. The electro-technical outer shell 140 defines an access aperture 144 on its forward side, and a wire passing aperture 145 on its bottom side. It is contemplated that in other embodiments, the access aperture 144 and the wire passing aperture 145 could be defined elsewhere on the electro-technical outer shell 140.

The rack assembly 200 also has an electro-technical access panel 146, which is connected to the forward side of the electro-technical outer shell 140 to cover the access aperture 144. The electro-technical access panel 146 has a disconnect switch handle 148 thereon.

The rack assembly 200 also has a wire pass-through panel 147, which is connected to the bottom side of the electro-technical outer shell 140 to cover the wire passing aperture 145, while allowing electrical wires to pass through, in order to connect the electrical wires to the system control unit 150.

The electrical unit 150 includes switch disconnect boxes 152 that are electrically connected to the disconnect switch handle 148, a fuse box 154, intermediate terminals 156, a system control unit 158 and the main power terminal 160, which is enclosed in high voltage safety shield 162. As will be explained in greater detail below, the electrical unit 150 is electrically connected to the battery modules 400.

It is contemplated that in other embodiments, the features on the left side of the present embodiment of the rack assembly 200 could be interchanged with the features on the right side of the present embodiment.

On its top side, the rack assembly 200 has one top access panel 170. Two top thermal insulation panels 172 are provided between the top access panel 170 and the frame 250. The top access panel 170 and the top thermal insulation panels 172 are connected to the frame 250. It is contemplated that in some embodiments there could be more than one top access panel 170 and/or that the number of top thermal insulation panels 172 could be different. In the present embodiment, the top access panel 170 and the two top thermal insulation panels 172 are removable so as to provide access to the interior of the rack assembly 200 from a top thereof. Below the two top thermal insulation panels 172, the rack assembly 200 has a heating box module 174. The heating box module 174 has heating elements (not shown) that can increase the temperature of the battery modules 400 as needed.

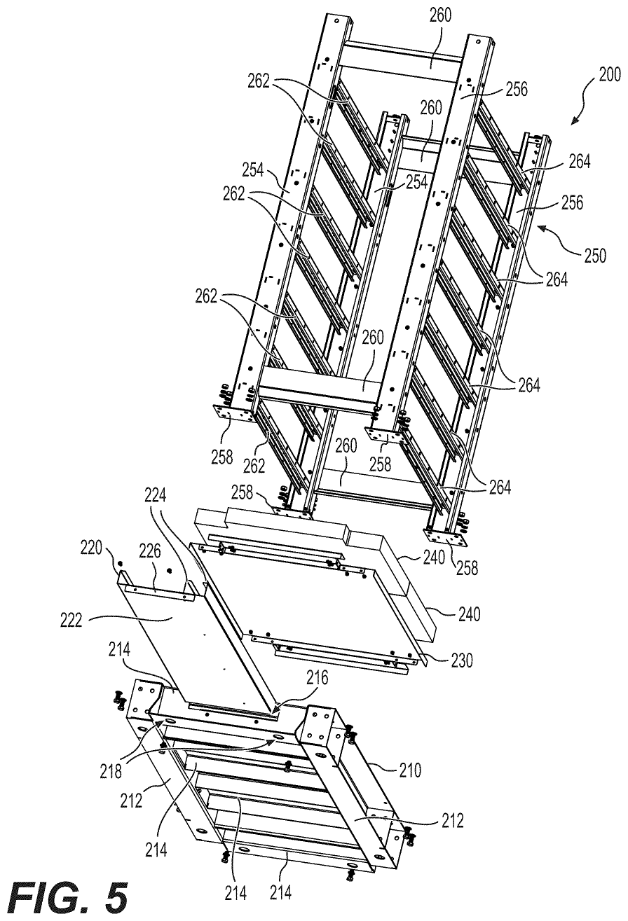

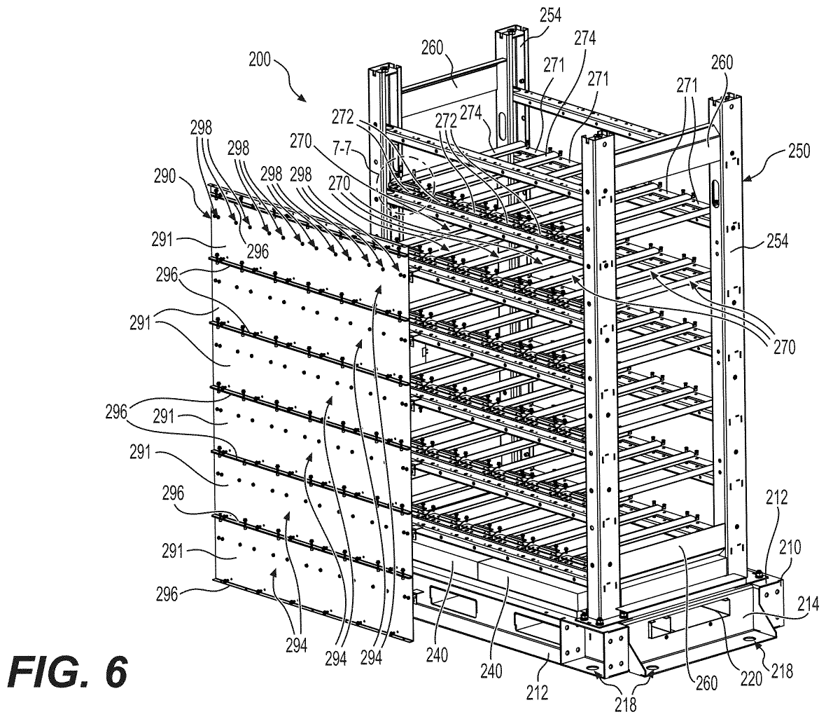

Referring to FIGS. 5 and 6, the rack assembly 200 will now be described in greater detail. In addition to the components described above, the rack assembly 200 has a base structure 210, a wiring tray 220, a bottom panel 230, and two bottom thermal insulation panels 240.

The base structure 210 is adapted to support the frame 250 and receive the wiring tray 220, the bottom panel 230 and the two thermal insulation panels 240. The base structure 210 has two lateral members 212, which are connected to one another by four longitudinal members 214. It is contemplated that in some embodiments, the number of longitudinal members 214 could be different. In other embodiments, the base structure 210 could be one integral member. Wiring tray apertures 216 (one of which is seen in FIG. 5) are defined on the lateral sides of the base structure 210, throughout the longitudinal members 214, such that the wiring tray 210 may be inserted therein. In the present embodiment, the base structure 210 is adapted to be anchored to a surface it is resting on, through anchoring apertures 218, thereby anchoring the rack assembly 200 to the surface. It is contemplated that in other embodiments, the anchoring apertures 218 could be omitted. In other embodiments, it is contemplated that the base structure 210 could have wheels or legs.

The wiring tray 220 is adapted to be inserted in the wiring tray apertures 216. The wiring tray 220 has a base 222, with lateral members 224 extending upwardly from the base 222. The base 222 also has a member 226 extending downwardly from a left side of the wiring tray 220. The member 226 acts as a stopper, by preventing the wiring tray 220 from being inserted too far in the wiring tray aperture 216 when the member 226 abuts the base structure 210. The member 226 is also used to fasten the wiring tray 220 to the base structure 210. It is contemplated that in some embodiments, the member 226 could extend from the right side of the wiring tray 220. In yet other embodiments, the member 226 could be omitted.

The bottom panel 230 is connected to the base structure 210. The two bottom thermal insulation panels 240 are provided between the bottom panel 230 and the frame 250. It is contemplated that in other embodiments, there could be more than one bottom panel 230 and/or that the number of bottom thermal insulation panels 240 could be different.

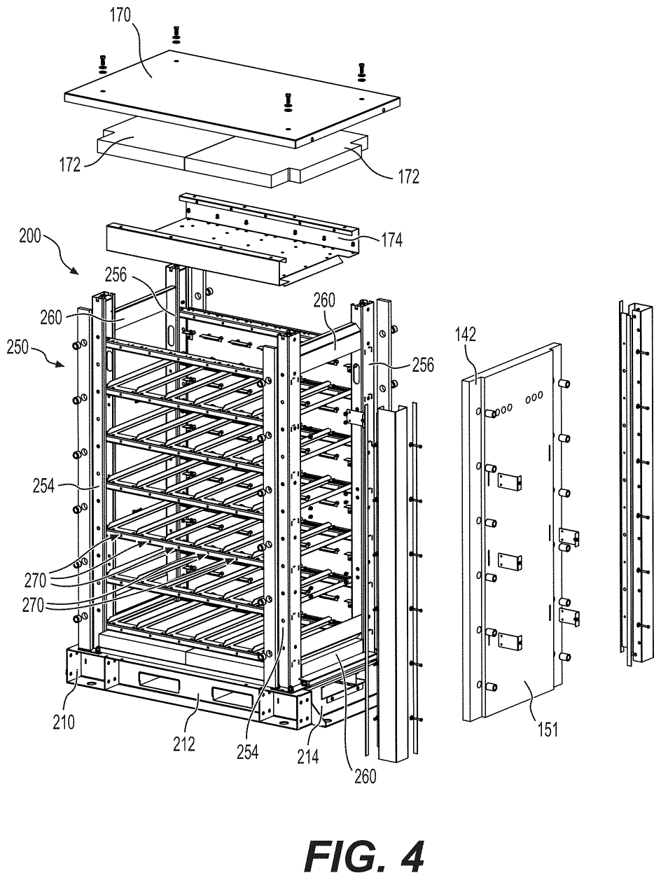

Referring to FIGS. 4 to 6, the frame 250 will now be described in greater detail. The frame 250 has two forward upstanding members 254, and two rearward upstanding members 256. It is contemplated that in other embodiments, the number of upstanding members 254, 256 could be different. On their bottom side, each of the upstanding members 254, 256 has a base connecting plate 258. The base connecting plates 258 connect the upstanding members 254, 256 to the base structure 210.

In the present embodiment, the forward upstanding members 254 are connected to the rearward upstanding members 256 by four linking members 260. It is contemplated that in some embodiments, the number of linking members 260 could be different.

The forward upstanding members 254 are connected to one another by forward shelf members 262, and the rearward upstanding members 256 are connected to one another by rearward shelf members 264. In the present embodiment, there are seven forward shelf members 262, and seven rearward shelf members 264. It is contemplated that in some embodiments, the number of forward and rearward shelf members 262, 264 could be more or less than seven. Each of the forward shelf members 262 is vertically aligned with a corresponding one of the rearward shelf members 264. The top shelf members 262, 264 are supporting members. Each of the other pairs of shelf members 262, 264 define a shelf. As such, the rack assembly 200 of the present embodiment has six shelves. It is contemplated that some embodiments, there could be more or less than six shelves. It is contemplated that in some embodiments, at least some of the pair of corresponding forward and rearward shelf members 262, 264 could be replaced by a single shelf member. As will be explained in greater detail below, each shelf is adapted to slidingly receive and support battery modules 400.

The frame 250 also has guiding brackets 270. The guiding brackets 270 extend longitudinally, and connect to the forward shelf members 262 and to the rearward shelf members 264. In the present embodiment, there are six guiding brackets 270 on each shelf. It is contemplated that in some embodiments, there could be more or less than six guiding brackets 270.

Each guiding bracket 270 has a forward shelf connecting portion 271, a rear shelf connecting portion 272, and two guiding members 274 extending in the longitudinal direction thereby connecting the forward and the rear shelf connecting portions 271, 272. The guiding members 274 project upward, generally perpendicularly to the shelf connecting portions 272, such that each guiding bracket 270 forms a C-shaped channel. The guiding brackets 270 are adapted to each receive one battery module 400. As will be explained in greater detail below, the guiding brackets 270 help to guide the battery module 400 to their predetermined position.

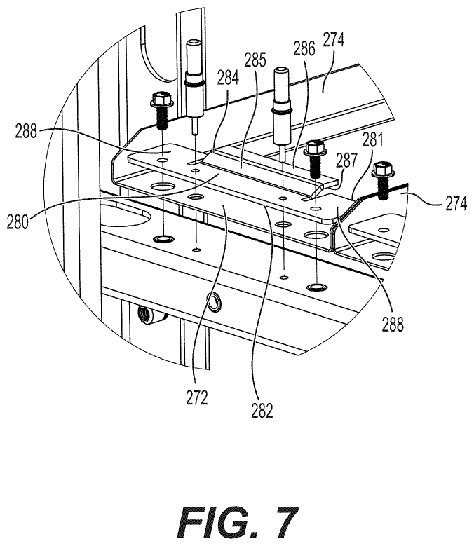

Referring to FIG. 7, the frame 250 also has stoppers 280. One of the stoppers 280 will be described in detail. The stopper 280 has a forward end 281 and a rear end 282. In the present embodiment, the stopper 280 is generally flat with an elevated member 284 that is vertically elevated relative to the forward end 281, and oriented to face the forward direction. In the present embodiment, the elevated member 284 has a sloped portion 285 and a flat portion 286. The elevated member 284 also has an interacting surface 287 on a bottom side of the flat portion 286. In the present embodiment, the elevated member 284 is laterally between two generally flat connecting members 288. In the present embodiment, the elevated member 284 is elevated with respect to the connecting members 288 by five millimetres. It is contemplated that in other embodiments, the elevated member 284 could be elevated with respect to the connecting members 288 by more or less than five millimetres. In the present embodiment, each one of the stoppers 280 is received between the guiding members 274 of a corresponding one of the guiding brackets 270, and is connected to a corresponding one of the rearward shelf members 264. It is contemplated that in some embodiments, the stoppers 280 could be integrally formed with the guiding brackets 270.

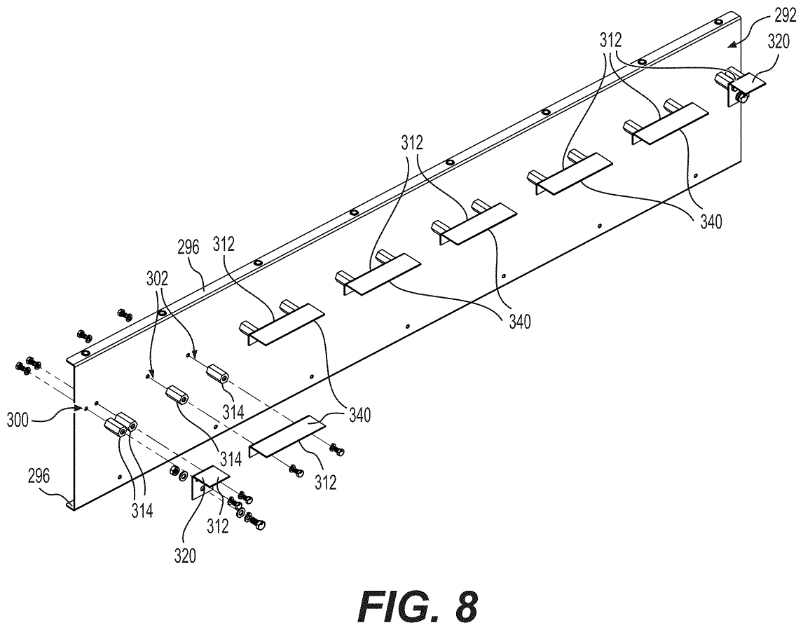

Referring to FIGS. 6 and 8, in the present embodiment, the rack assembly 200 also has a rear wall 290 adapted to be connected to the frame 250. The rear wall 290 is made of six rear wall portions 291. It is contemplated that in other embodiments, the number of rear wall portions 291 could be different. The rear wall portions 291 have a forward surface 292 and a rearward surface 294. Each of the rear wall portions 291 has top and bottom members 296 projecting generally perpendicularly from the rearward surface 294 in the rearward direction. The top and bottom members 296 are used to connect the rear wall portions 291 to one another, and thus form the rear wall 290. Each of the rear wall portions 291 defines fourteen connection apertures 298 extending therethrough. More specifically, there are four edge connection apertures 300, and ten intermediate connection apertures 302. The edge connection apertures 300 are closely spaced, and the ten intermediate connection apertures 302 are more distantly spaced.

The rear wall 290 has power busbars 312 connected thereto. Each of the power busbars 312 is electrically conductive, and is connected to one of the rear wall portions 291 by two insulating spacers 314. In the present embodiment, the insulating spacers 314 electrically insulate the rear wall portions 291 from their power busbar 312. There are two types of power busbars 312:

there are edge power busbars 320 and intermediate power busbars 340. In the present embodiment, there are two edge power busbars 320 and six intermediate power busbars 340 per shelf. The power busbars 312 are arranged such that the two edge power busbars 320 are positioned at each outermost extremity of a corresponding one of the rear wall portions 291, while the six intermediate power busbars 340 are evenly positioned therebetween.

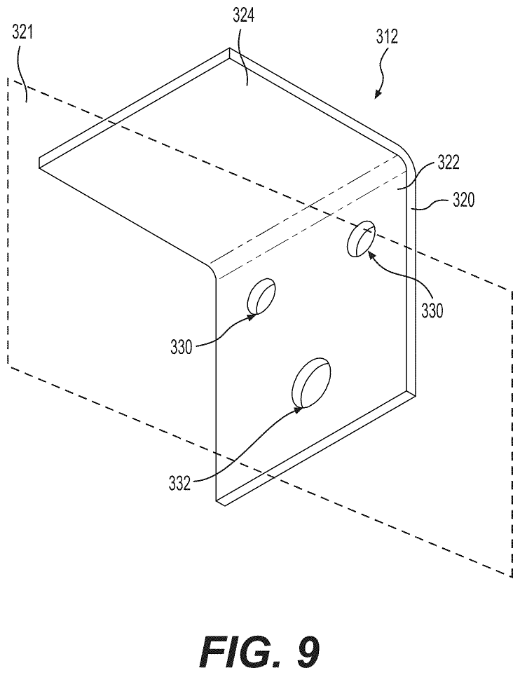

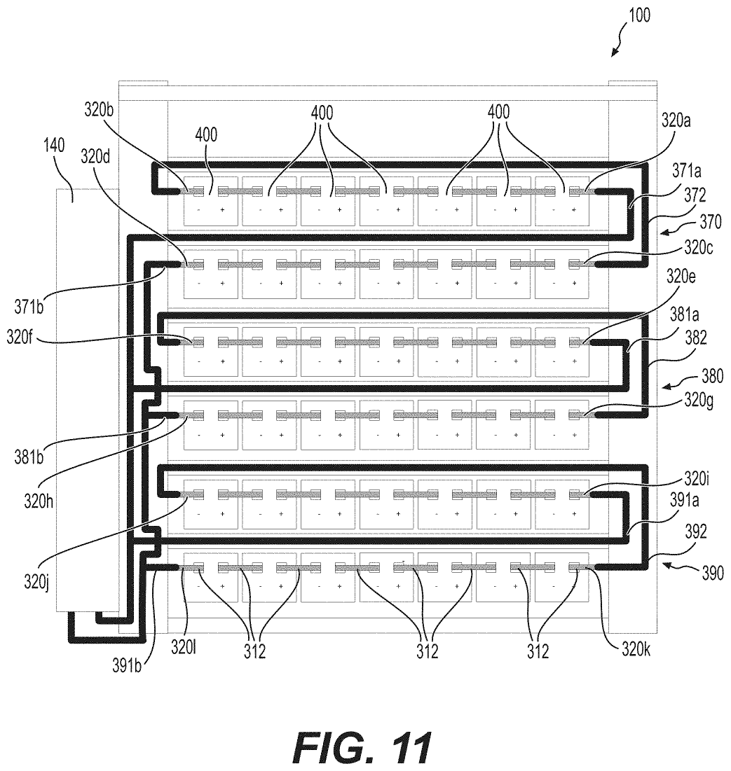

Referring to FIG. 9, the edge power busbars 320 will now be described in greater detail. Each of the edge power busbars 320 has a wall connecting portion 322 extending generally perpendicularly to a blade portion 324 to form an L-shape. The wall connecting portion 322 symmetrically defines two connection apertures 330 about a center plane 321. The two connection apertures 330 are adapted to receive fasteners that connect the insulating spacers 314 to the edge power busbars 320. The wall connecting portion 322 also defines one wiring aperture 332. The center of the wiring aperture 332 is aligned with the center plane 321. The wiring aperture 332 is used for connecting the edge power busbar 320 to an electrical wire (such as electrical wire 372 shown in FIG. 11). In the present embodiment, the two connection apertures 330 are vertically above the wiring aperture 332. In the present embodiment, the edge power busbars 320 are connected to the rear wall portion 291 such that the blade portion 324 is oriented to be at the top of the power busbars 320. It is contemplated that in some embodiments, the edge power busbars 320 could be oriented differently. For instance, the edge power busbar 320 could be oriented such that the blade portion 324 is oriented to be at the bottom or at the side of the edge power busbar 320.

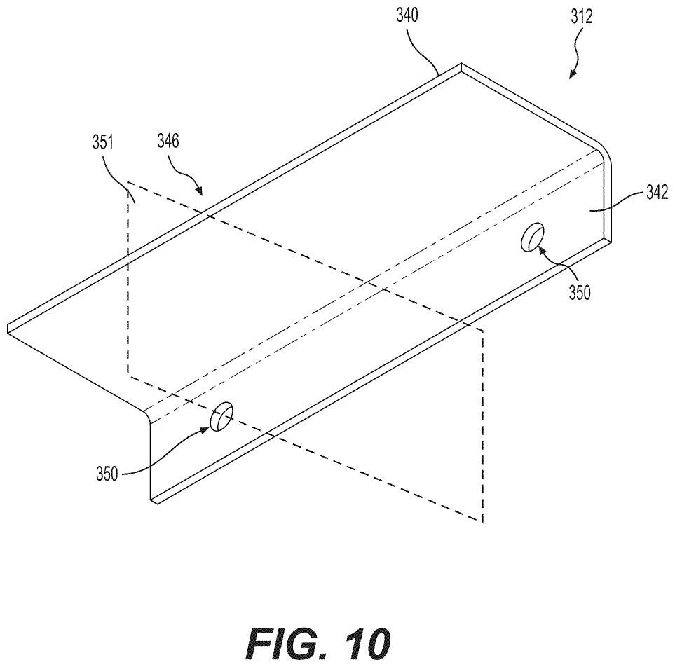

Referring to FIG. 10, the intermediate power busbars 340 will now be described in greater detail. Each of the intermediate power busbars 340 has a wall connecting portion 342 extending generally perpendicularly to a blade portion 344 to form an L-shape. The wall connecting portion 342 symmetrically defines two connection apertures 350 about a center plane 351. The two connection apertures 350 are adapted to receive fasteners that connect the insulating spacers 314 to the intermediate power busbars 340. In the present embodiment, the intermediate power busbars 340 are wider than the edge power busbars 320. In the present embodiment, the intermediate power busbars 340 are almost three times wider than the edge power busbars 320. It is contemplated that in some embodiments, the intermediate power busbars 340 could be more or less than three times wider than the edge power busbars 320. As will be explained in greater detail below, the intermediate power busbars 340 are wider in order to be connected to two adjacent battery modules 400. In the present embodiment, the intermediate power busbars 340 are connected to the rear wall portion 291 such that the blade portion 344 is oriented to be at the top of the intermediate power busbars 340. It is contemplated that in some embodiments, the intermediate power busbars 340 could be oriented differently. For instance, the intermediate power busbars 340 could be oriented such that the blade portion 344 is oriented to be at the bottom or at the side of the intermediate power busbars 340.

Referring to FIG. 11, a wiring system of the energy storage unit 100 will be described. The wiring system electrically connects the power busbars 312 and the battery modules 400 to the main power terminal 160. In the present embodiment, the energy storage unit 100 has three groups of battery modules 370, 380, 390 that are connected in parallel to the main power terminal 160. Each one of the three groups of battery modules 370, 380, 390 has twelve battery modules 400 connected in series by the power busbars 312. In the present embodiment, the battery modules 400 of the top two shelves are connected in series and define the first group 370. The right edge power busbar 320a of the top shelf is electrically connected to the main power terminal 160 by an electric wire 371a. The left edge power busbar 320b of the top shelf is electrically connected to the right edge power busbar 320c of the shelf below by electrical wire 372. The left edge power busbar 320d of this shelf is electrically connected to the main power terminal 160 by an electric wire 371b. The battery modules 400 of the two middle shelves are connected in series and define the second group 380. The right edge power busbar 320e of the upper middle shelf is electrically connected to the main power terminal 160 by an electric wire 381a. The left edge power busbar 320f of the upper middle shelf is electrically connected to the right edge power busbar 320g of the shelf below by electrical wire 382. The left edge power busbar 320h of this shelf is electrically connected to the main power terminal 160 by an electric wire 381b. The battery modules 400 of the two bottom shelves are electrically connected in series and define the third group 380. The right edge power busbar 320i of the upper bottom shelf is electrically connected to the main power terminal 160 by an electric wire 391a. The left edge power busbar 320j of the upper bottom shelf is electrically connected to the right edge power busbar 320k of the bottom shelf by electrical wire 392. The left edge power busbar 320l of this shelf is electrically connected to the main power terminal 160 by an electric wire 3910b.

It is contemplated that in other embodiments, the wiring system could be different. For instance, there could be more or less than three groups and/or each group could have more or less than twelve batteries connected in series.

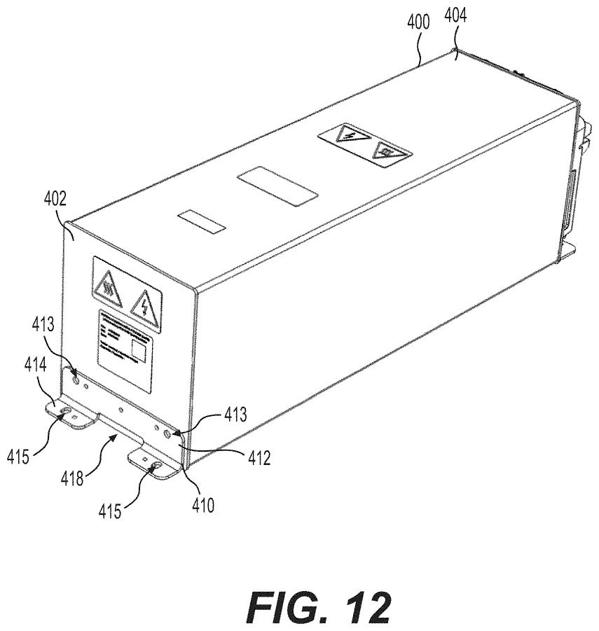

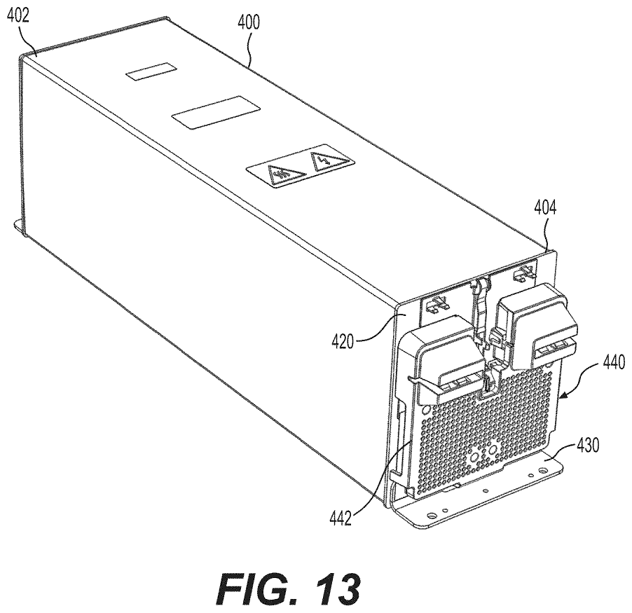

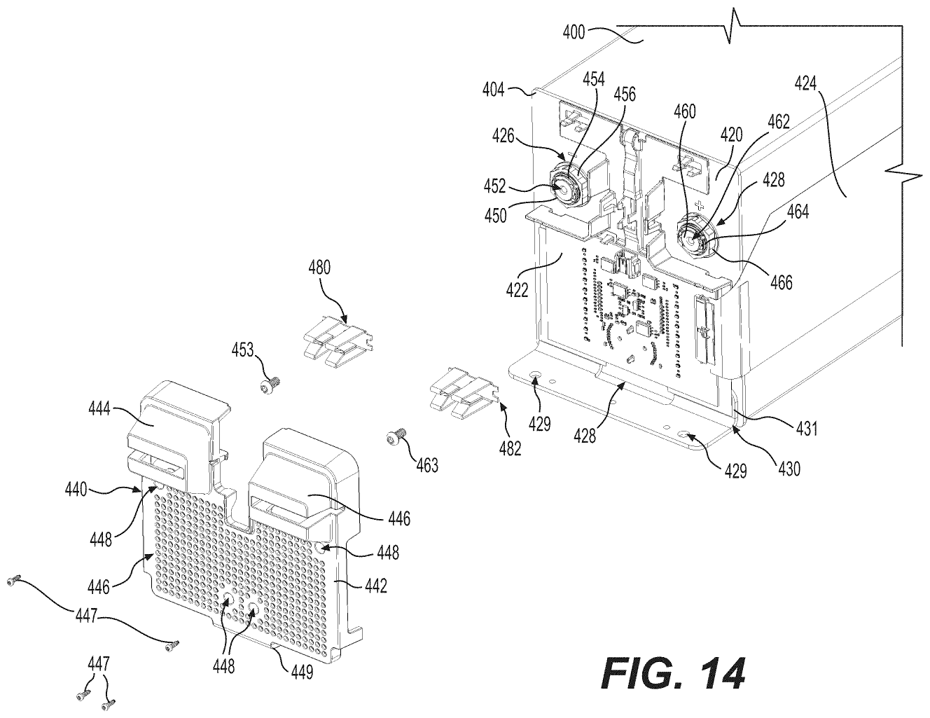

Referring to FIGS. 12 to 14, the battery modules 400 will be described in greater detail. Each of the battery modules 400 has a front end 402 and a rear end 404.

In the present embodiment, each of the battery modules 400 has an L-shaped fixing bracket 410. The fixing bracket 410 has a module connecting portion 412 connected to the front end 402 of the battery module 400. The fixing bracket 410 also has a frame connecting portion 414 that is generally perpendicular to module connecting portion 412. The module connecting portion 412 defines connecting apertures 413 such that in some embodiments, the fixing bracket 410 could be fastened to the battery module 400, where the battery modules 400 would be adapted to receive fasteners. In the present embodiment, however, the module connecting portion 412 is welded to the front end 402 of the of the battery module 400. The frame connecting portion 414 defines connecting apertures 415 used to fasten the fixing bracket 410 to the frame 250. The frame connecting portion 414 also defines a recess 418. As will be explained in greater detail below, the fixing bracket 410 prevents its corresponding battery module 400 from moving in the longitudinal direction. It is contemplated that in other embodiments, the fixing bracket 410 could be adapted to connect to a top portion of one of the battery modules 400, and could have another shape. It is contemplated that in some embodiments, the fixing bracket 410 could be omitted.

The rear end 404 of each of the battery modules 400 has a rear casing cover 420 that hermetically seals the inside of the battery modules 400. An L-shaped engaging bracket 430 and a ventilation cover 440 are connected to the rear casing cover 420.

The engaging bracket 430 has a module connecting portion 431 connected to the rear casing cover 420. The engaging bracket 430 also has an engaging portion 432 that is generally perpendicular to the module connecting portion 431. An aperture 428 is defined in a corner of the engaging bracket 430. The aperture 428 aids in locking the ventilation cover 440 to the battery module 400. Connecting apertures 429 are also defined in the engaging bracket 430 such that the engaging bracket 430 could be connected to the frame 250 in some embodiments. As will be explained in greater detail below, in the present embodiment, the engaging bracket 430 is not connected to the frame 250 through the connecting apertures 429.

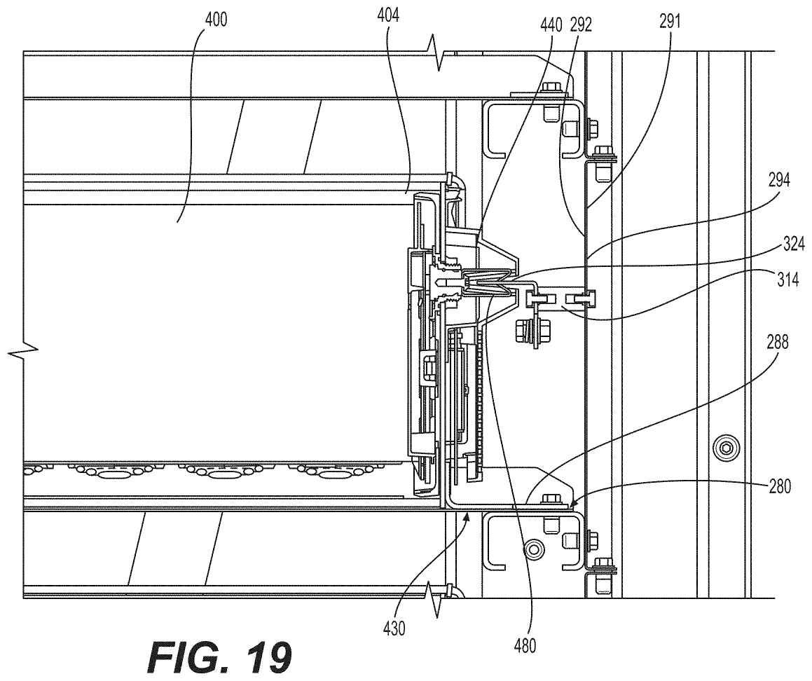

The ventilation cover 440 has a body 442. The body has receiving receptacles 444, 446 adapted for receiving busbar blade connectors 480, 482 (best seen in FIG. 19). The body 442 defines a plurality of ventilation apertures 446, such that air can flow therethrough. The body 442 further defines four connection apertures 448. The four connection apertures 448 receive fasteners 447, which connect the ventilation cover 440 to the rear of the battery module 400. The body 442 also has a locking member 449 extending from a bottom portion of the ventilation cover 440, that is received in the aperture 428 of the engaging bracket 430.

A circuit board 422 is disposed between the ventilation cover 440 and the rear casing cover 420. The circuit board 422 is connected to a ribbon connector 424. The ribbon connector 424 extends from the rear end 404 along the right side of battery module 400, and has resistive circuits integrated therein.

Each of the battery modules 400 also has, on its rear end 404, the busbar blade connectors 480, 482 which are connected to power posts 450, 460. The busbar blade connectors 480, 482 will be described in greater detail below.

The power post 450 has a negative electrical polarity, and partially extends through a cover aperture 426. The power post 450 defines a chamfered threaded hole 452 in its middle. The chamfered threaded hole 452 receives a threaded fastener 453 to connect the busbar blade connector 480. The power post 450 further has a threaded connector 454 to which a nut 456 is fastened.

The power post 460 has a positive electrical polarity, and partially extends through a cover aperture 428. The power post 460 defines a chamfered threaded hole 462 in its middle. The chamfered threaded hole 462 receives a threaded fastener 463 to connect the busbar blade connector 482. The power post 460 further has a threaded connector 464 to which a nut 466 is fastened.

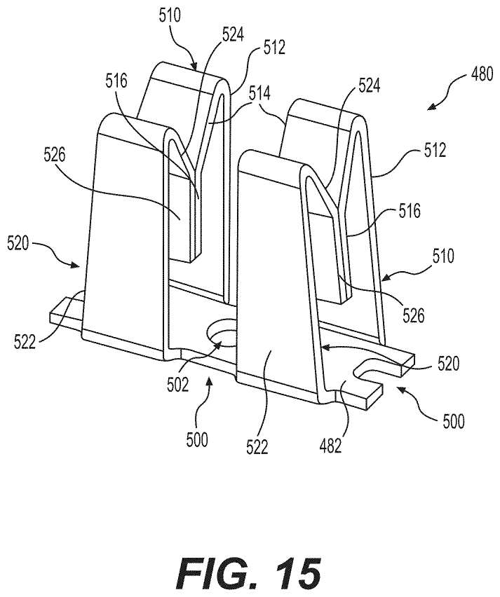

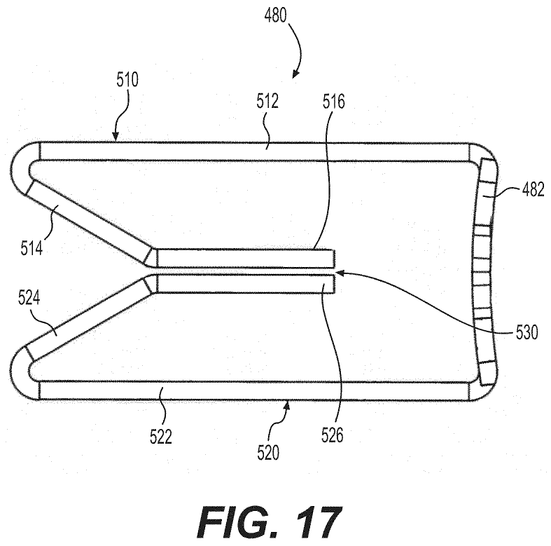

Referring to FIGS. 15 to 17, the busbar blade connectors 480, 482 will now be described in greater detail. As the busbar blade connectors 480, 482 are identical, only the busbar blade connector 480 will be described in detail.

The busbar blade connector 480 has a base portion 482. In the present embodiment, the busbar blade connector 480 is generally vertically and laterally symmetrical. It is contemplated that in other embodiments, the busbar blade connector 480 could be vertically and/or laterally asymmetrical. The base portion 482 defines recesses 500 along a center of its upper, lower and lateral edges. The base portion 482 also defines an aperture 502 in a center thereof. The aperture 502 receives the fastener 453, connecting the base portion 482 to the power post 450 via the chamfered threaded hole 452.

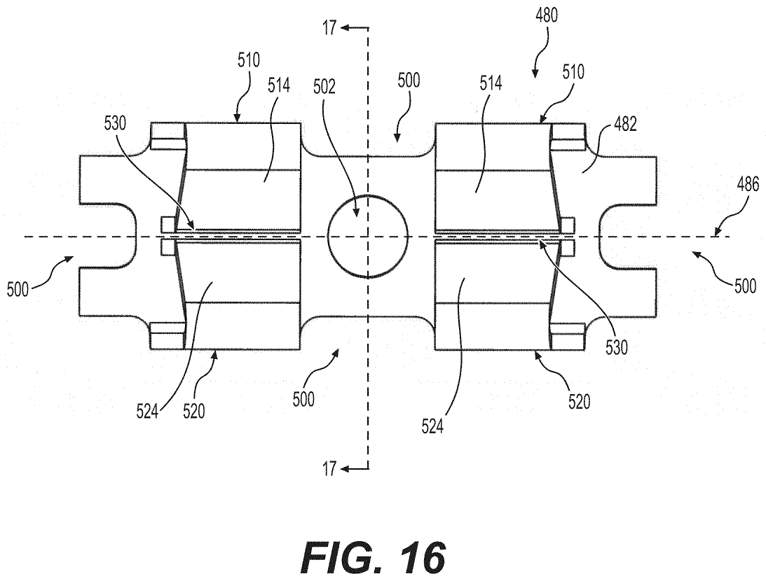

The busbar blade connector 480 has two upper arms 510 and two lower arms 520 that are electrically conductive and resilient. As will be explained in greater detail below, the upper and lower arms 510, 520 are biased toward their initial position shown in FIGS. 15 and 16 upon displacement of any one of the upper and lower arms 510, 520. It is contemplated that in other embodiments, there could be only one upper arm 510 and one lower arm 520. It is also contemplated that there could be three or more upper arms 510, and/or three or more lower arms 520.

The two upper arms 510 each have an upper arm member 512 extending generally perpendicularly away from the base portion 482 up to a rear end. An upper arm member 514 extends forwardly from the rear end of the upper arm member 512 diagonally toward a horizontal center plane 486 of the busbar blade connector 480 and toward the base portion 482 to a front end of the upper arm member 514. An upper arm member 516 extends horizontally from the front end of the upper arm 514 toward the base portion 482. The upper arm member 516 is generally parallel to the upper arm member 512.

The two lower arms 520 each have a lower arm member 522 extending generally perpendicularly away from the base portion 482 up to a rear end. A lower arm member 524 extends forwardly from the rear end of the lower arm member 522 diagonally toward the horizontal center plane 486 and toward the base portion 482 to a front end of the lower arm member 524. A lower arm member 526 extends horizontally from the front end of the lower arm 524 toward the base portion 482. The lower arm member 526 is generally parallel to the first lower arm member 522.

In the present embodiment, each of the two upper arms 510 is laterally aligned with one of the two lower arms 520. Also, the upper arm members 512 are parallel to the lower arm members 522 and the upper arm members 516 are parallel to the lower arm members 526.

In the present embodiment, the busbar blade connector 480 is made from a single piece of copper. It is contemplated that in other embodiments, the busbar blade connector 480 could be made from another electrically conductive and resilient metal. It is also contemplated that in some embodiments, the busbar blade connector 480 could be plated, with silver, gold, nickel or tin for example, to improve electrical conductivity thereof and/or to improve resistance to corrosion. The piece of copper is bent to the shape described above, and seen in FIGS. 15 and 16.

In the present embodiment, two connecting regions 530 are defined between the upper and lower arm members 516, 526 of the busbar blade connector 480. As will be explained in greater detail below, the blade portion 324 of a power busbar 312 enters the connecting regions 530 so that the upper and lower arms 510, 520 contact the blade portion 324 or 344 (as the case may be), resulting in electrical connection between the busbar blade connector 480 and a corresponding power busbar 312.

It is contemplated that in other embodiments, the busbar blade connectors 480, 482 could be another type of busbar blade connectors.

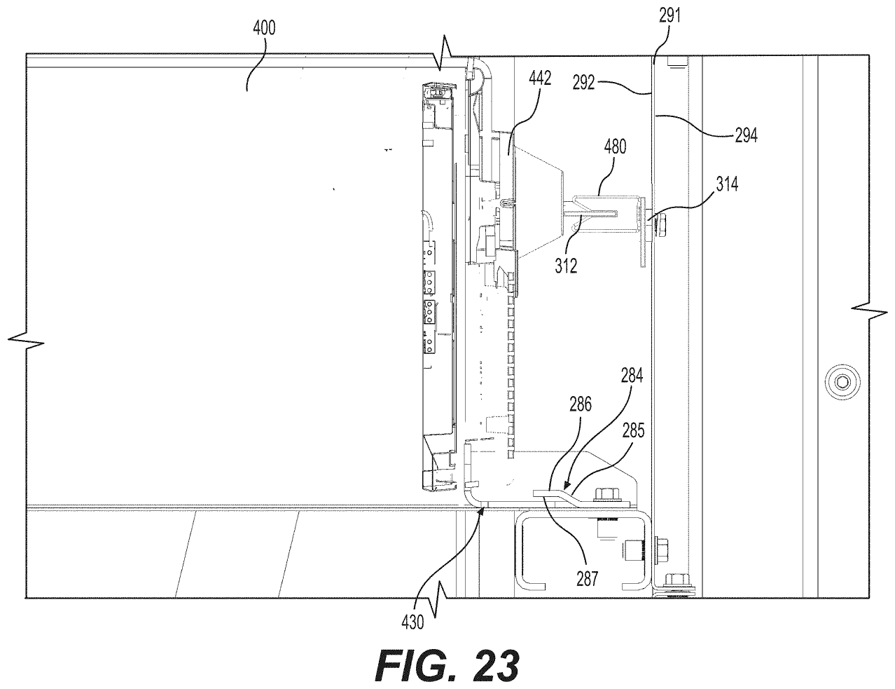

It is contemplated that in some embodiments, as shown in FIG. 23, the energy storage unit 100 could be configured such that the busbar blade connectors 480 are connected to the rear wall 290, and the power busbars 312 are connected to the battery modules 400.

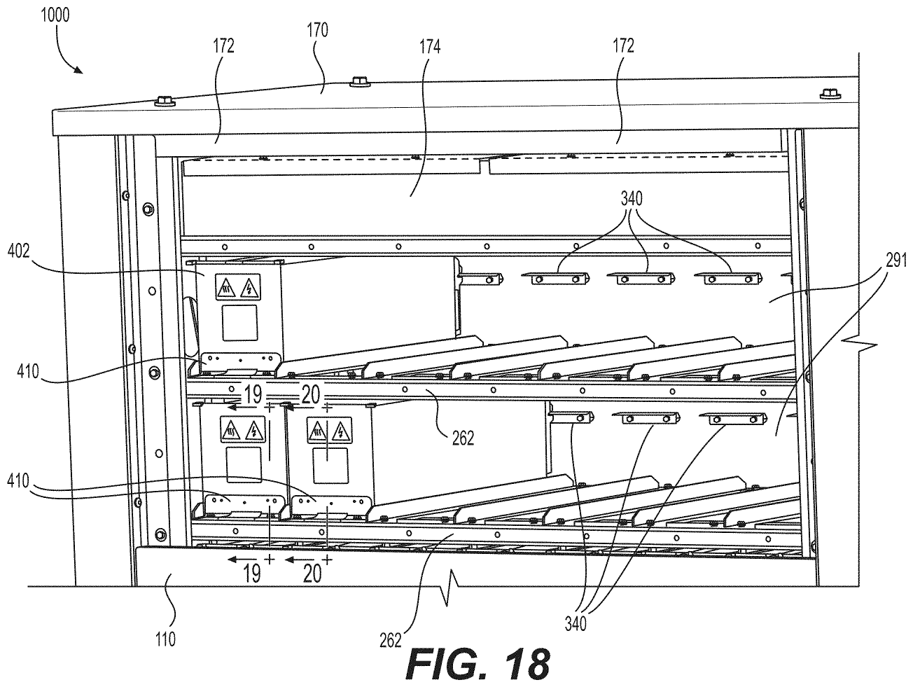

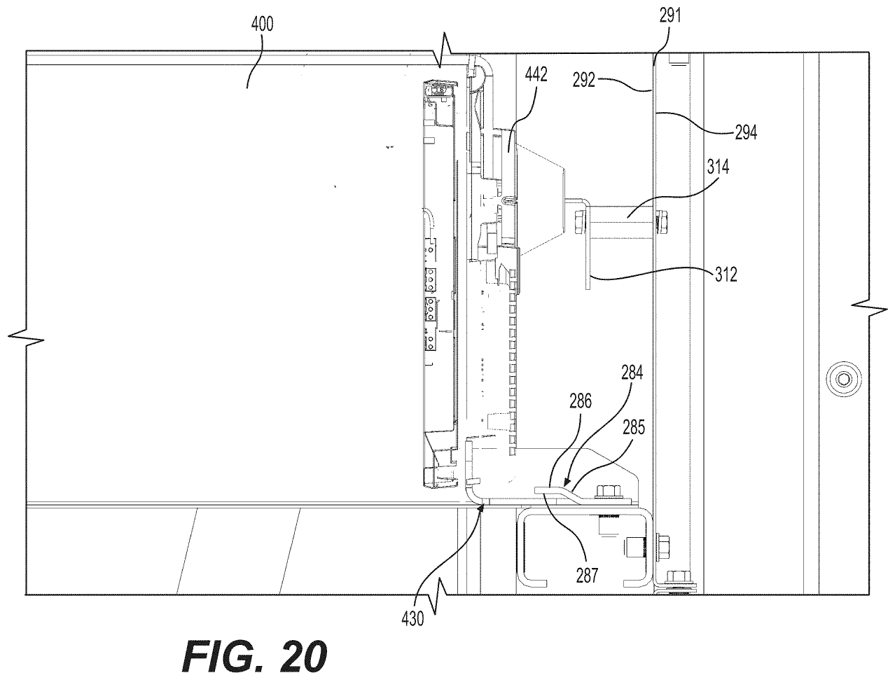

Referring now to FIGS. 18 to 22, the connection process between the battery modules 400 and the rack assembly 200 will be described with reference to an alternate embodiment of the energy storage unit 100. The alternate embodiment of energy storage unit 1000 generally has the same features as the embodiment shown in FIGS. 1 to 17, however the number of shelves and the number of battery modules 400 per shelf is different. In the alternate embodiment described below, there are eight shelves, with each shelf supporting seven battery modules 400. Features of the energy storage unit 1000 that are similar to those of the energy storage unit 100 described above have been labeled with the same reference numerals and will not be described again in detail.

The forward access panels 110 and the forward thermal insulation panels 112 are removed to access the interior of the rack assembly 200. As previously mentioned, the forward access panels 110 and the forward thermal insulation panels 112 are easily removable for this purpose.

Once the interior of the rack assembly 200 is accessible, one of the battery modules 400 is inserted by sliding the battery module 400 onto a shelf of the frame 250. More specifically, the battery module 400 is slid onto a guiding bracket 270. The guiding members 274 of the guiding bracket 270 laterally guide the battery module 400 as the battery module 400 slides to its predetermined position, as shown in FIGS. 18 and 19. The battery module 400 is known to have reached the predetermined position when the engaging bracket 430 abuts the corresponding stopper 280 which stops the movement of the battery module 400 in the longitudinal direction. More precisely, when the battery module 400 reaches the predetermined position, the engaging portion 432 of the engaging bracket 430 abuts the stopper 280 thereby stopping the battery module 400 from being inserted past the predetermined position. In the predetermined position, the engaging portion 432 of the engaging bracket 430 is under the interacting surface 287 of the elevated member 284, which, as will be described in greater detail below, limits vertical movement of the battery module 400. In the present embodiment, the connecting apertures 429 of the engaging bracket 430 are not used, as the stopper 280 fulfills generally the same purpose as the connecting apertures 429, that is to limit movement of the battery module 400 with respect to the frame 250. In addition, using the connecting apertures 429 would require an installer to access the rear side of the energy storage unit 1000 to insert fasteners through the connecting apertures 429 to fasten the engaging bracket 430 to the frame 250.

As the battery module 400 is sliding to the predetermined position, the two busbar blade connectors 480, 482 each slidingly connect to a power busbar 312 by having the blade portions 324 or 344 (as the case may be) enter the connecting regions 530 of their respective busbar blade connectors 480, 482, as seen in FIG. 19 for the busbar blade connector 480.

When the blade portions 324, 344 enter the connecting regions 530, the upper and lower arms 510, 520 are displaced from their initial position. Since the upper and lower arms 510, 520 are biased toward their initial position, the upper and lower arms 510, 520 apply compressive forces to the blade portions 324, 344. The power busbars 312 are positioned such that the blade portions 324, 344 of the power busbars 312 are vertically aligned with the connecting regions 530 of the busbar blade connectors 480, 482 when the battery modules 400 are in the predetermined position. In the present embodiment, the blade portions 324, 344 can be vertically aligned with the connecting regions 530 of the busbar blade connectors 480, 482 within a tolerance of five millimetres or less. In other embodiments, the tolerance could be three millimetres or less. In some embodiments, the tolerance could be 1.5 millimetres or more. The tolerance is in part provided by upper and lower arm members 514, 524, as the upper and lower arm members 514, 524 can bend to conform to the vertical misalignment.

As previously mentioned, in the present embodiment, the stopper 280 and the engaging bracket 430 can interact to limit vertical movement of the rear end 404 of battery module 400, so that the vertical alignment between the blade portions 324, 344 and the busbar blade connectors 480, 482 remains less than five millimetres. It is contemplated that in other embodiments, the stopper 280 and the engaging bracket 430 could limit the vertical movement by more or less than five millimetres. In the present embodiment, when the battery module 400 is in the predetermined position, and the rear end 404 of battery module 400 begins to move in the vertical direction, a top of the engaging portion 432 which as explained above is below the elevated member 284, abuts the interacting surface 287 of the elevated member 284, thereby preventing the rear end 404 of the battery module 400 from further being displaced in the vertical direction.

Once the battery module 400 is in the predetermined position, its fixing bracket 410 is connected to the frame 250 by fastening the frame connecting portion 414 of the fixing bracket 410 to the forward shelf member 262 through the connecting apertures 415. The fixing bracket 410 further fixes the battery module 400 in the predetermined position such that movement in the forward and vertical direction is prevented.

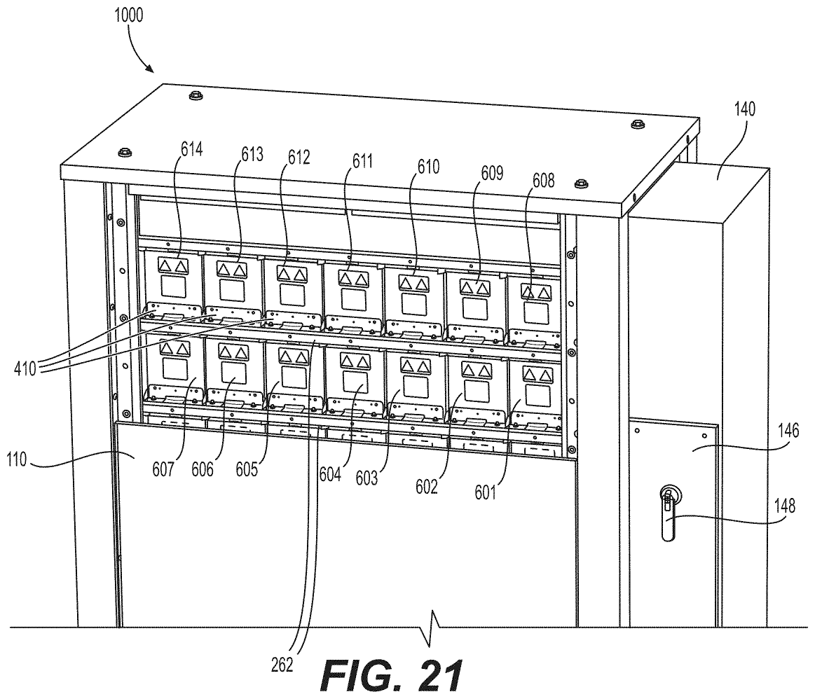

These steps are repeated until all seven battery modules 400 for each of the eight shelves are positioned in the predetermined position, as shown in FIG. 21.

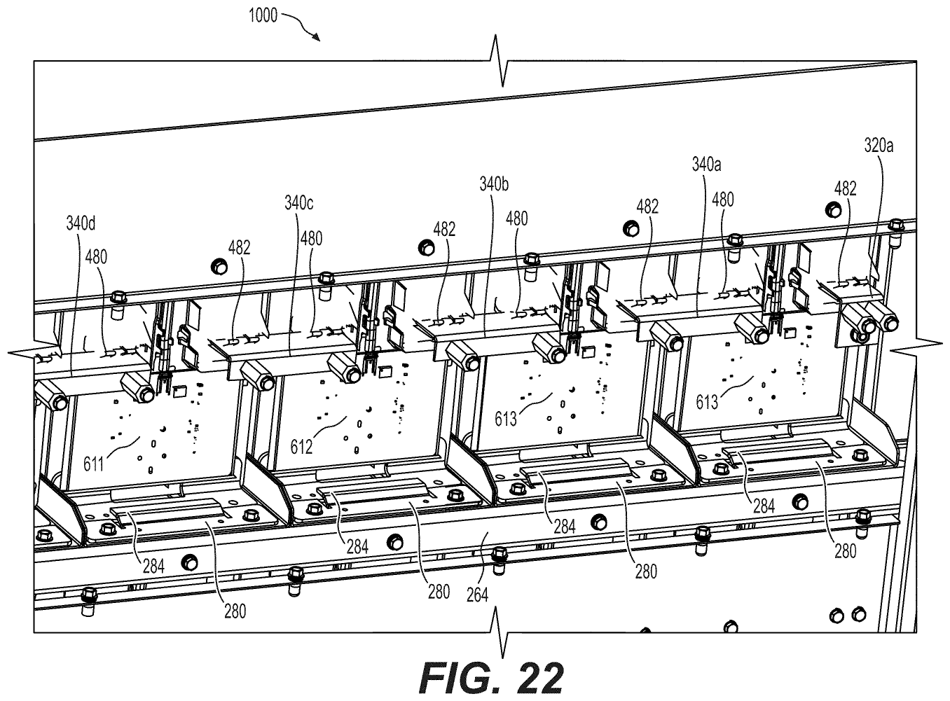

Referring now to FIGS. 21 and 22, the electrical connections in the energy storage unit 1000, when the electrical circuit is closed, will now be described. Reference to the battery modules 400 will henceforth be made based on their position in the energy storage unit 1000. There are battery modules 601, 602, 603, 604, 605, 606, 607, 608, 609, 610, 611, 612, 613, 614.

As explained above, each of the battery modules 601, 602, 603, 604, 605, 606, 607, 608, 609, 610, 611, 612, 613, 614 has a busbar blade connector 480 that is connected to the negative power post 450, and therefore has a negative polarity, and has a busbar blade connector 482 that is connected to the positive power post 460, and therefore has a positive polarity.

The busbar blade connector 482 of the battery module 614 is electrically connected to the right edge power busbar 320a. As previously explained, the right edge power busbar 320a is electrically connected to the main power terminal 160 by an electrical wire (not shown in FIG. 22). The busbar blade connector 480 of the battery module 614 is electrically connected to the intermediate power busbar 340a.

The busbar blade connector 482 of the battery module 613 is electrically connected to the intermediate power busbar 340a, thereby electrically connecting battery module 613 to battery module 614. The busbar blade connector 480 of the battery module 613 is electrically connected to the intermediate power busbar 340b.

The busbar blade connector 482 of the battery module 612 is electrically connected to the intermediate power busbar 340b, thereby electrically connecting battery module 612 to battery module 613. As such, battery modules 612, 613, 614 are electrically connected in series. The busbar blade connector 480 of the battery module 612 is electrically connected to the intermediate power busbar 340c.

The busbar blade connector 482 of the battery module 611 is electrically connected to the intermediate power busbar 340c, thereby electrically connecting battery module 611 to battery module 612. As such, battery modules 611, 612, 613, 614 are electrically connected in series. The busbar blade connector 480 of the battery module 612 is electrically connected to the intermediate power busbar 340d.

The battery modules 609, 610 are connected to intermediate power busbar 340 as described in the above paragraph, and the battery module 608 is connected to the left edge power busbar 340 (not shown in FIG. 22) and the intermediate power busbar 340, similarly to the battery module 614. The battery modules 608, 609, 610, 611, 612, 613, 614 are thus electrically connected in series.

The battery modules 601, 602, 603, 604, 605, 606, 607 are connected to their respective power busbars 312 similarly to the battery modules 608, 609, 610, 611, 612, 613, 614, and given that, as described above, the left edge power busbar 320 of the top shelf is electrically connected to the right edge power busbar 320 of the shelf below, the battery modules 601, 602, 603, 604, 605, 606, 607, 608, 609, 610, 611, 612, 613, 614 are electrically connected in series. As also described above, given that the right edge power busbar 320 of this shelf is connected to the main power terminal 160, the electrical circuit between the battery modules 601, 602, 603, 604, 605, 606, 607, 608, 609, 610, 611, 612, 613, 614 is closed.

When the electrical circuit is closed, current flows throughout the energy storage unit 1000 from the battery modules 400 to the main power terminal 160. An operator may stop the current flowing through the energy storage unit 1000 by operating the disconnect switch handle 148. The disconnect switch handle 148 is electrically connected to the switch disconnect boxes 152, which upon operation of the disconnect switch handle 148 disconnect the main power terminal 160 from the battery modules 400.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. An energy storage unit comprising:
a rack assembly; and
a plurality of battery modules supported by the rack assembly, the rack assembly comprising:
a frame having at least one shelf, the at least one shelf being adapted to receive the plurality of battery modules thereon;
a plurality of first electrical connectors connected to the frame, the plurality of first electrical connectors being electrically insulated from the frame;
a system control unit connected to the frame; and
a main power terminal selectively electrically connected to the plurality of battery modules,
each battery module of the plurality of battery modules having two second electrical connectors at a rear thereof, each one of the two second electrical connectors being selectively slidingly connected to one first electrical connector of the plurality of first electrical connectors, and
the first and second electrical connectors being configured such that inserting the plurality of battery modules on the at least one shelf by sliding the plurality of battery modules on the at least one shelf connects the second electrical connectors with the first electrical connectors.

2. The energy storage unit of claim 1, wherein the first electrical connectors are power busbars, and the second electrical connectors are busbar blade connectors.

3. The energy storage unit of claim 1, wherein the first electrical connectors are busbar blade connectors, and the second electrical connectors are power busbars.

4. The energy storage unit of claim 1, wherein the plurality of second electrical connectors includes:
a base portion selectively connected to the battery module;
a resilient upper arm connected to the base portion; and
a resilient lower arm connected to the base portion,
the resilient upper and lower arms defining a connecting region therebetween and having an initial position, the resilient upper and lower arms being biased toward the initial position upon displacement of any one of the resilient upper and lower arms.

5. The energy storage unit of claim 1, wherein the plurality of second electrical connectors include:
a base portion selectively connected to the battery module, the base portion defining a center plane;
an upper arm connected to the base portion, the upper arm having:
a first upper arm member extending away from the base portion to a first end of the first upper arm;
a second upper arm member connected to the first end of the first upper arm member, the second upper arm member extending diagonally from the first end of the first upper arm toward the center plane and the base portion to a second end of the second upper arm; and
a third upper arm member connected to the second end of the second upper arm member, the third upper arm extending toward the base,
a lower arm connected to the base portion, the lower arm having:
a first lower arm member extending away from the base portion to a first end of the first upper arm;
a second lower arm member connected to the first end of the first lower arm member, the second lower arm member extending diagonally from the first end of the first lower arm toward the center plane and the base portion to a second end of the second lower arm; and
a third lower arm member connected to the second end of the second lower arm, the third lower arm extending toward the base,
the third upper arm member and the third lower arm member defining a connecting region therebetween, and
the upper and lower arm having an initial position, and being biased toward the initial position.

6. The energy storage unit of claim 1, wherein each first electrical connector of the plurality of first electrical connectors is vertically aligned with at least one second electrical connector of the plurality of second electrical connectors within a tolerance of five millimetres or less. The energy storage unit of claim 6, wherein the tolerance is three millimetres or less.

8. The energy storage unit of claim 6, wherein the tolerance is 1.5 millimetres or more.

9. The energy storage unit of claim 1, wherein at least some battery modules of the plurality of battery modules are connected in series.

10. The energy storage unit of claim 1, wherein at least some battery modules of the plurality of battery modules are connected in parallel.

11. The energy storage unit of claim 1, wherein the plurality of battery modules comprises:
a first group of battery modules connected in series; and
a second group of battery modules connected in series, the first group of battery modules being connected in parallel with the second group of battery modules.

12. The energy storage unit of claim 1, wherein:
the frame has a plurality of guiding brackets; and
each battery module of the plurality of battery modules is received laterally in one guiding bracket of the plurality of guiding brackets.

13. The energy storage unit of claim 12, wherein each of the plurality of guiding brackets forms a C-shaped channel.

14. The energy storage unit of claim 1, wherein the frame further includes a plurality of stoppers, the plurality of stoppers stopping the plurality of battery modules from sliding past a predetermined position on the at least one shelf when the second electrical connectors are connected to the first electrical connectors.

15. The energy storage unit of claim 1, wherein each battery module of the plurality of battery modules has a fixing bracket, the fixing bracket being selectively fixedly connected to the frame.

16. The energy storage unit of claim 1, wherein the at least one shelf is at least six shelves, and each one of the at least six shelves receives at least one battery module of the plurality of battery modules.

17. An energy storage unit comprising:
a rack assembly; and
a plurality of battery modules supported by the rack assembly, each battery module of the plurality of battery modules defining a first module end and a second module end, the second module end having an engaging bracket selectively fixedly connected thereto,
the rack assembly comprising:
a frame having:
at least one shelf adapted to receive the plurality of battery modules therein; and
a plurality of stoppers each defining a first end and a second end, the first end having an elevated member,
a system control unit connected to the frame; and
a main power terminal selectively electrically connected to the plurality of battery modules,
each battery module being selectively slidingly inserted in the rack assembly by sliding on the at least one shelf to a predetermined position, and
when one of the plurality of battery modules is in the predetermined position, a corresponding one of the elevated member of the plurality of stoppers, limits vertical movement of the one of the plurality of battery modules by selectively engaging the engaging bracket of the one of the plurality of battery modules.

18. The energy storage unit of claim 17, wherein the corresponding one of the elevated member of the plurality of stoppers limits vertical movement of the one of the plurality of battery modules to less than five millimetres.

19. The energy storage unit of claim 18, wherein vertical movement is limited to less than three millimetres.

20. The energy storage unit of claim 17 further including:
a plurality of first electrical connectors connected to the frame, the plurality of first electrical connectors being electrically insulated from the frame; and
each battery module of the plurality of battery modules having two second electrical connectors at a rear thereof, each one of the two second electrical connectors being selectively slidingly connected to one first electrical connector of the plurality of first electrical connectors.
